(19) United States
(12) Patent Application Publication
(10) Pub. No.: US 2004/0100761 A1
(43) Pub. Date: May 27, 2004

(54) Rotatable mechanism of removable computer peripheral device

(76) Inventor: Dana Liu, Hsin-Tien City (TW)

Correspondence Address: BROWDY AND NEIMARK, P.L.L.C., 624 NINTH STREET, NW, SUITE 300, WASHINGTON, DC, 20001-5303, US

(21) Appl. No.: 10/300,786

(22) Filed: Nov. 21, 2002

(51) Int. Cl. G06F 1/16

(52) U.S. Cl. 361/685

(57) ABSTRACT

A removable computer peripheral device includes a pull-out bay, a rotabable mechanism installed in one side of the pull-out bay and including a signal connector, a mounting rack attached to the signal connector, the mounting rack rotatably installed in the pull-out bay. It is very convenient users because the mounting rack can be rotated to the position where the peripheral device can be installed to pull-out bay without limitation of space.

### BACKGROUND OF THE INVENTION

1. Field of the Invention

The present invention relates to a removable computer peripheral device with rotatable mechanism, and in particular, to the removable computer peripheral device that is swap in any position and is not limited by conventional pull-out bay when the peripheral device is connected with signal cable connector. Therefore, it is convenient for user to use the computer peripheral device that is install in the pull-out bay.

2. Description of the Prior Art

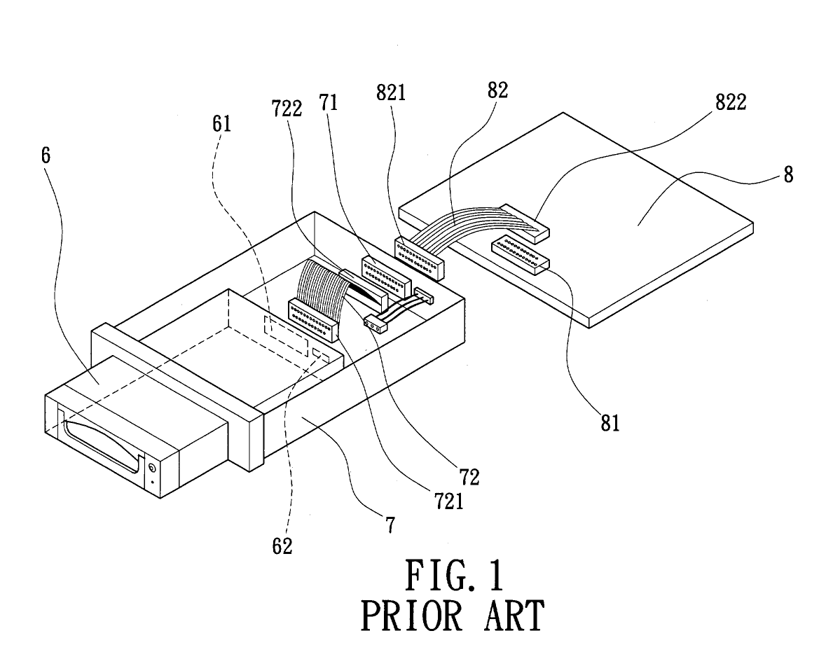

Conventional computer peripheral device such as hard disk, optical disc drive, floppy disk drive and recordable optical disc drive can be easily installed in computer by a pull-out bay. These computer peripheral devices can be removably installed in the pull-out bays and mounted on the computer by mounting brackets. Referring to FIG. 1, the drawing is the schematic of the conventional removable hard disk drive wherein it includes a hard disk drive 6 and a pull-out bay 7. The hard disk drive includes an interface connector 61 and an electrical outlet 62. A signal connector 71 is defined on within the enclosure of the pull-out bay 7. When users would like to assemble the hard disk drive 6 and the pull-out bay 7, one connector 721 of the ribbon cable 72 within the pull-out bay 7 is plugged into the interface connector 61 of the hard disk drive 6, and the other connector 722 of the ribbon cable 72 is connected with a signal connector 71 of the pull-out bay 7. Then, a power cable 73 of the pull-out bay 7 is plugged into the electrical outlet 62 of the hard disk drive 6. Furthermore, a ribbon cable 82 is electrically connected with the ribbon cable 72 of the pull-out bay 7 by the one connector 821, and the other connector 822 is electrically connected with an interface connector 81 of a motherboard 8 by the other connector 822. After a power cable is plugged into the electrical power connector of the pull-out bay 7, the assembly is complete.

As mentioned above, when the hard disk drive 6 that is installed in the pull-out bay 7, the ribbon cable 72 is fixed in the pull-out bay 7 and cannot be rotated. Thus, the hard disk drive 6 that is installed in the pull-out bay 7 is horizontally mounted on the brackets of the pull-out bay 7 and is connected with the ribbon cable 72. It causes much trouble to assembly procedures.

In order to overcome the shortcomings of conventional device, the present invention provides a novel removable computer peripheral device with rotatable mechanism.

### SUMMARY OF THE DISCLOSURE

It is an object of the present invention to provide a removable computer peripheral device with rotatable mechanism wherein the removable computer peripheral device that is connected with a signal connector of a pull-out bay is not limited by the pull-out bay and is still connected with the signal connector when the peripheral device is any position. Therefore, it is more convenient to use the removable computer peripheral device that is installed in the pull-out bay.

It is another object of the present invention to provide a removable computer peripheral device, comprising a pull-out bay, a rotatable mechanism installed in one side of the pull-out bay and including a signal connector, a mounting rack attached to the signal connector, the mounting rack rotatably installed in the pull-out bay. Thus, the removable computer peripheral device is installed in the pull-out bay, the signal connector can be rotated through a chosen angle by the mounting rack The computer peripheral device can be connected with the signal connector to the position, and the mounting rack can be restored to normal position and be secured after the installation is finished. Thus, the computer peripheral device can be horizontally installed in the pull-out bay.

It is further object of the present invention to provide a removable computer peripheral device wherein a mounting rack is attached to a pull-out bay by mounting screws. When users want to rotate a signal connector, users then needs to loose the mounting screws and rotate the mounting rack together with the signal connector to a mounting position. After the installation of: the computer peripheral device and the signal connector is complete, the computer peripheral device will be horizontally positioned in the pull-out bay and the mounting rack will also be returned to original position. Meanwhile, fasten the mounting screws in order that the mounting rack will not be rotated arbitrarily and the peripheral device will be firmly placed in the pull-out bay.

It is an another object of the present invention is to provide a removable computer peripheral device wherein two outwardly protuberances are integrally formed on both sidewalls of a mounting track and sized to be received in two corresponding holes that are formed on the rear of two sidewalls of a pull-out bay. The rotatable mechanism can be pivotally coupled to two outwardly protuberances, and the mounting rack will not disengage from the pull-out bay even mounting screws are loosen.

### BRIEF DESCRIPTION OF THE INVENTION

FIG. 1 is schematic showing the configuration of removable device in the prior art;

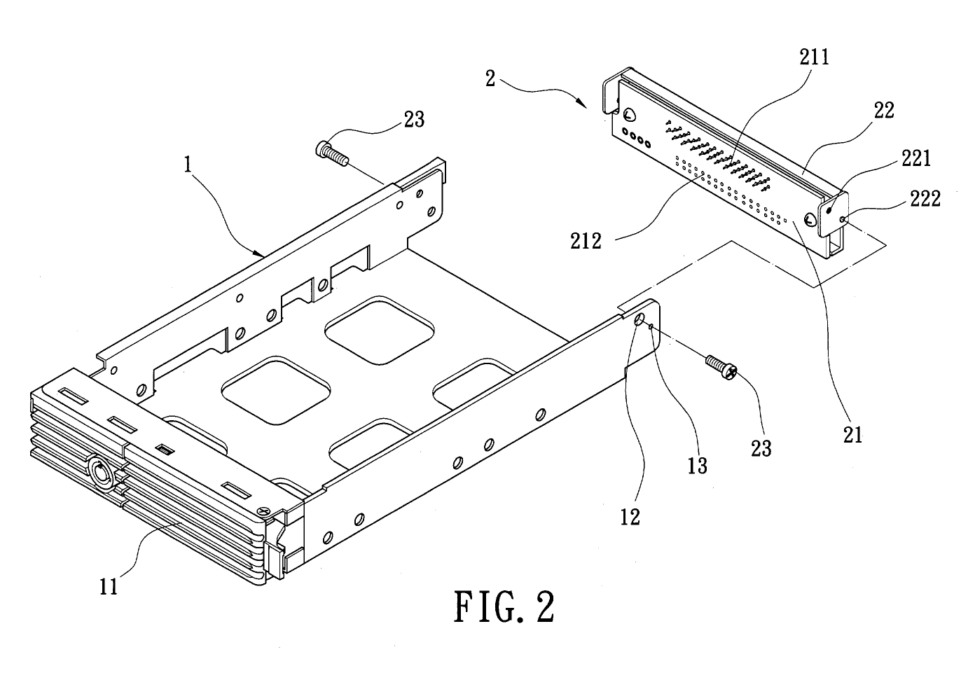

FIG. 2 is a top perspective view of the present invention with a mounting rack detached;

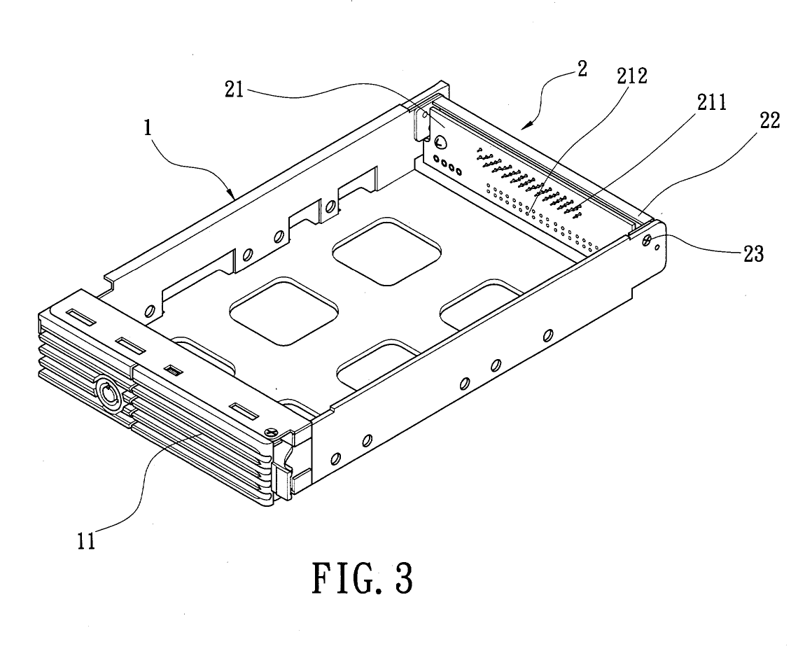

FIG. 3 is a top perspective view of FIG. 2 with the mounting rack fastened; and

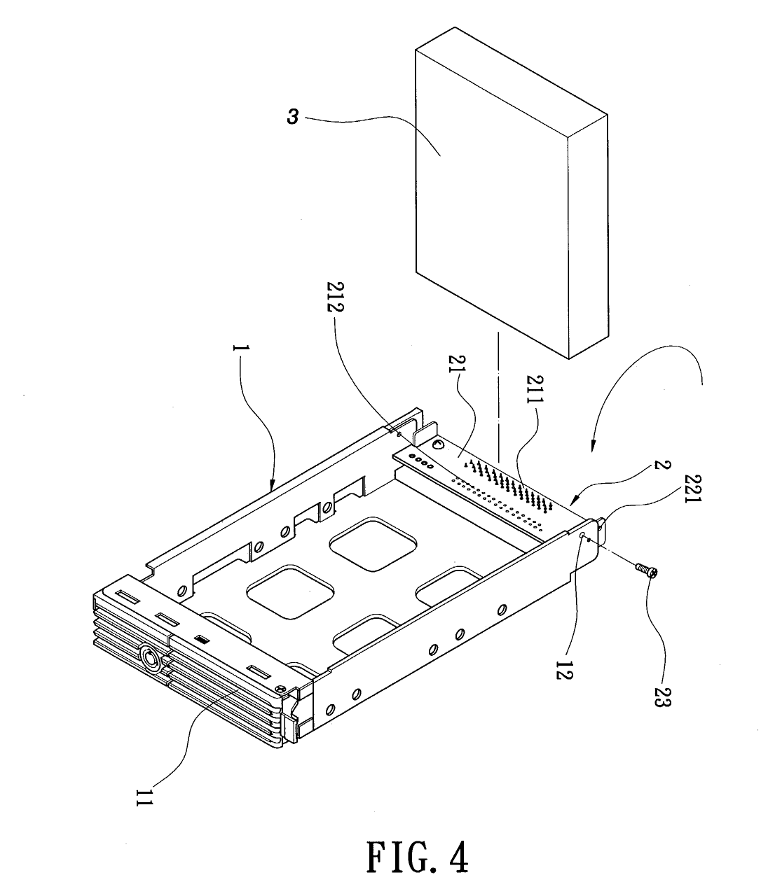

FIG. 4 illustrates how a removable peripheral device can be adapted to the pull-out bay according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

As shown in FIG. 2, the present invention relates to a removable computer peripheral device with rotatable mechanism. The removable computer peripheral device includes a pull-out bay 1 of rectangular frame shape. The pull-out-bay 1 has an open front face, an open top face and an open rear face. Optionally, a a bezel 11 is provided at front end of the pull-out bay 1 to cover the open front face. A computer peripheral 3 can be installed into the pull-out bay 1 through the open top face. A rotabable mechanism 2 is detachably fastened to the rear face of the pull-out bay 1.

According to the present invention, the rotatable mechanism 2 includes a signal connector 21 having plurality of pins 211 and holes 212 installed thereon for connecting the computer peripheral device 3. There are also plurality of pins and holes (not shown) installed in the other side of the signal connector 21 for connecting with a motherboard. A mounting rack 22 is coupled to the signal connector 21, and the mounting rack is U-shaped and pivotally connected to the pull-out bay 1. Two screw holes are formed on two sidewall of the mounting rack 22, and two corresponding screw holes 12 are defined on the rear of pull-out bay 1. Furthermore, two protuberances 222 are outwardly installed near the screw holes 12 of the mounting rack 22, and two positioning holes 13 are provided in the rear end of the pull-out bays 1.

As shown in FIG. 3, when the rotatable mechanism 2 is rotabably coupled to the pull-out bay 1, the signal connector 21 and the mounting rack 22 are rotatably coupled to the rear end of the pull-out bay 1, and two protuberances 222 formed in the sidewall of the mounting rack 22 is received in two positioning holes 13, thereby causing the rotatable mechanism 2 to pivot by the protuberances 222. A mounting screw 23 is screwed through screw holes 12 and 221 in order that the rotatable mechanism 2 is coupled to the pull-out bay 1.

Referring to FIG. 4, the computer peripheral device, such as a hard disk drive as preferred in this embodiment is installed in the pull-out bay 1. When installation, loose the mounting screw 23. Because the mounting rack 22 is coupled to the pull-out bay 1 by the protuberances 22, even the users loose the mounting screws, the mounting rack 22 will not be disengaged from the pull-out bay 1. Meanwhile, with protuberances 222 the mounting rack 22 together with the signal connector 21 can be rotated to a position where the hard disk drive will be uprightly adapted to the signal connector 21. After the installation is finished, the computer peripheral device 3 will be horizontally positioned in the pull-out bay 1. The mounting rack 22 will be returned to the original position. At this time, fasten the mounting screw 23 in order that the mounting rack 22 will be arbitrarily rotated.

In accordance with the present invention, the signal connector is rotatable to most position where the computer peripheral device can be installed in the pull-out bay 1 without limitation of space. It is much more convenient for users to install the computer peripheral device to the pull-out bay 1.

While the description above refers to particular embodiments of the present invention, it will be understood that many-modifications may be without departing from the spirit thereof. The accompanying claims are intended to cover such modifications as would fall within the true scope and spirit of the present invention.

What is claimed is:

1. A removable computer peripheral device with rotatable mechanism, comprising:
a pull-out bay of rectangular shape and having at least one open portion at one of a front face and a rear face thereof;
a rotabable mechanism installed in the rear face of the pull-out bay and including a signal connector, the signal connector having one side connecting with the peripheral device and another side connecting with a motherboard, a mounting rack attached to the signal connector, the mounting rack being rotatably-installed at rear face of the pull-out bay through at least one connecting member,
wherein the mounting rack and the signal connector are rotated to a predetermined inclined-angle with respect to the pull-out bay when a removable computer peripheral device is to be installed to the pull-out bay, the mounting rack and the signal connector are restored to a horizontal orientation after the computer peripheral device is connected to the signal connector.

2. The device according to claim t, wherein the peripheral device is a hard disk drive.

3. The device according to claim 1, wherein two screw holes are provided on two sidewalls of the mounting rack and another corresponding two screw holes are defined on the rear portion of lateral walls of the pull-out bay, thereby the rotatable mechanism being coupled to the pull-out bay by a connecting member.

4. The device according to claims 1 or 3, wherein the connecting member is a screw.

5. The device of claim 1, wherein two outwardly protuberances are integrally formed on both sidewalls of a mounting track and sized to be received in two corresponding holes that are formed on the rear of two sidewalls of a pull-out bay, the rotatable mechanism being pivotally coupled to two outwardly protuberances

6. The device according to claim 1, wherein the rotatable mechanism: includes a signal connector having plurality of pins and holes installed thereon for connecting the computer peripheral device, and plurality of pins and holes being installed in the other side of the signal connector for connecting with a motherboard.
